(19) United States
(12) Patent Application Publication
(10) Pub. No.: US 2025/0120365 A1
(43) Pub. Date: Apr. 17, 2025

(54) Pet Watering System

(71) Applicants: Tyndal Myishia Clark, East Point, GA (US); Kema Zawadi Tillman, East Point, GA (US)

(72) Inventors: Tyndal Myishia Clark, East Point, GA (US); Kema Zawadi Tillman, East Point, GA (US)

(21) Appl. No.: 18/379,156

(22) Filed: Oct. 11, 2023

(51) Int. Cl. A01K 7/00

(52) U.S. Cl. CPC A01K 7/00

(57) ABSTRACT

A travel friendly and self-contained pet watering system is disclosed. The pet watering system comprises a vessel that is a combination of a water bottle and water bowl. The vessel is formed of reusable or biodegradable materials in addition to being portable and self-contained. The trough has a removable seal that allows water from the interior of the bottle to fill the trough for the pet to drink. The trough and vessel have any suitable shape that is fit for a pet to drink from, including but not limited to, parallelepiped, semi-spherical, round, square, rectangular, etc. The vessel is easily carried in a backpack, cooler, or where any other typical water bottles would be carried. The vessel provides a convenient and sanitary source for pet hydration.

### REFERENCE TO RELATED APPLICATIONS

THIS APPLICATION CLAIMS PRIORITY TO PROVISIONAL UTILITY PATENT APPLICATION NO. 63/415,608 FILED ON Oct. 12, 2022. PROVISIONAL UTILITY PATENT APPLICATION NO. 63/415,608 IS INCORPORATED BY REFERENCE HEREIN. APPLICANT CLAIMS THE EARLIER FILING DATE.

### BACKGROUND

Many pet owners, particularly dog owners, when out walking or traveling with their pets find that either there is no place for their animal to drink water or no water bowl, or the like, instantly available. Owners and pets alike must stay hydrated for good health. Therefore, it behooves the owner to carry a receptacle and separate water source, or the multiple component type watering system, which are either overly cumbersome, or misplaced or lost.

### BRIEF SUMMARY OF THE INVENTION

This invention relates to a pet watering system that is portable. Moreover, it is a self-contained vessel, having water sealed within, and released into a bowl or trough when ready for use. In addition, in one aspect, the watering device is reusable and refillable. In another aspect, the watering device is single use or disposable. It is particularly valuable to provide a reliable source of water and receptacle for pet owners to carry or purchase easily and quickly while out with their pets. It is common to find pet owners traveling with their pet, so it is important to have a portable watering system that is functional, and reusable or disposable.

### BRIEF DESCRIPTION OF THE DRAWINGS

FIG. 1 shows a perspective view of an aspect of the invention.

FIG. 2 shows an exploded view of the aspect of the invention.

FIG. 3 presents a side elevational view of the aspect of the invention.

FIG. 4 is a cross sectional view of FIG. 3 along line 4-4.

FIG. 5 shows a top elevational view of the aspect of the invention.

FIG. 6 illustrates a perspective view of another aspect the invention.

FIG. 7 shows an exploded view of the aspect of the invention of FIG. 6.

FIG. 8 illustrates a side elevational view of the invention of FIG. 6.

FIG. 9 shows is a cross sectional view of FIG. 8 along line 9-9.

FIG. 10 presents a top elevational view of another aspect of the invention.

FIG. 11 illustrates an elevational view of a further aspect of the invention.

FIG. 12 shows the invention as if on a store shelf, containing water therein.

FIG. 13 presents side elevational view of the invention preparing for use.

FIG. 14 illustrates the removal of the seal when using the invention.

FIG. 15 shows the trough filling with water from the interior of the vessel.

FIG. 16 shows the trough and the interior of the vessel reaching equilibrium level of water.

FIG. 17 illustrates an elevational view of an additional aspect of the invention.

FIG. 18 illustrates another elevational view of an aspect of the invention.

FIG. 19 illustrates a cross-section view of FIG. 18.

### DETAILED DESCRIPTION AND BEST MODE OF IMPLEMENTATION

The present invention is a portable, reusable or disposable, self-contained watering device for pets. The primary goal of the invention is to provide a portable device to provide water for pets to drink from, while traveling, walking, camping, hiking, etc., in instances where access to water and a receptacle for the pet to drink from. In this invention, a pet may drink from a receptacle, for example a bowl, dish, container, trough, channel, etc. The term trough, generally speaking, a concave shape with an open top, will represent all types of water holding receptacles that allow animals to drink from.

A basic purpose of the invention is to provide a convenient, economical, and practical solution to providing a pet with necessary hydration while travelling, hiking, walking, etc. The ability to provide hydration with a disposal watering system is essential to the health and well-being of any animal, and as such the ability to provide water for hydration is quintessential to maintain balance, energy, and life itself. A proper and ecological way to provide hydration while traveling, especially in instances where water is not as easily accessible, is by either a reusable or a disposable container. If disposable, preferably a biodegradable or eco-friendly container would be paramount. Such materials for containers have become more readily available in recent years due to the advent of plant-based products and the formulations of biodegradable plastics.

With reference to the invention, a watering device is shown to include a vessel defining an internal volume for holding a predetermined volume of water. The vessel has the form of a parallelepiped structure, that is, at least six sides, where one side is a base, and opposite the base side is a front/top. The front side has a depression extending into the vessel forming a trough, bowl, dish, or the like, hereafter referred to as a trough. The trough having at least one aperture, a removable seal is affixed to the aperture. Upon placing the vessel on a support surface, the seal is removed from the aperture, and the water contained in the interior volume of the vessel fills into the trough. The animal is allowed to hydrate appropriately.

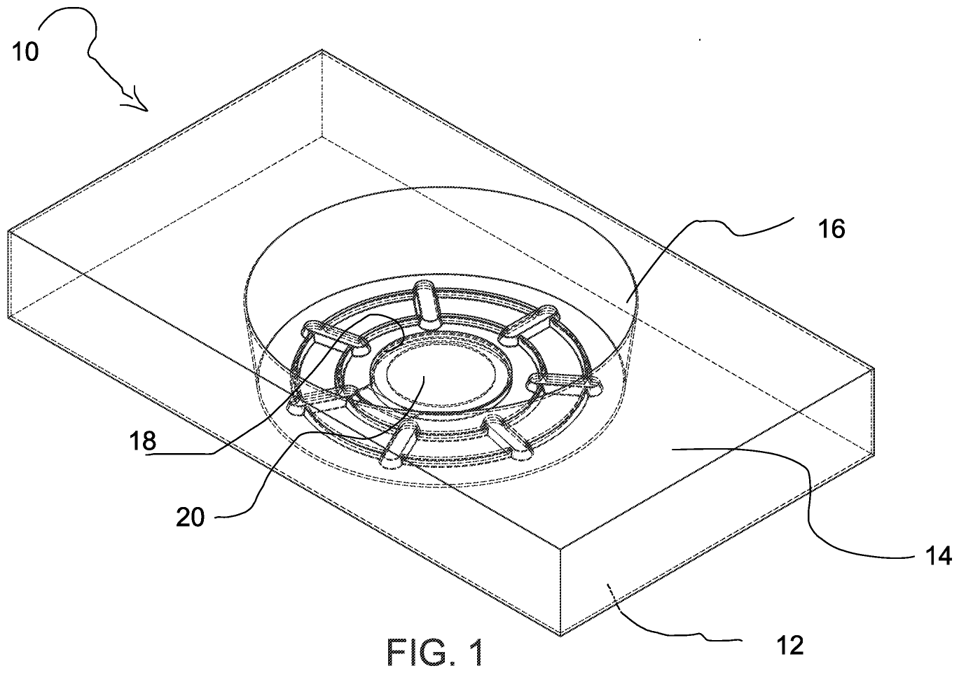

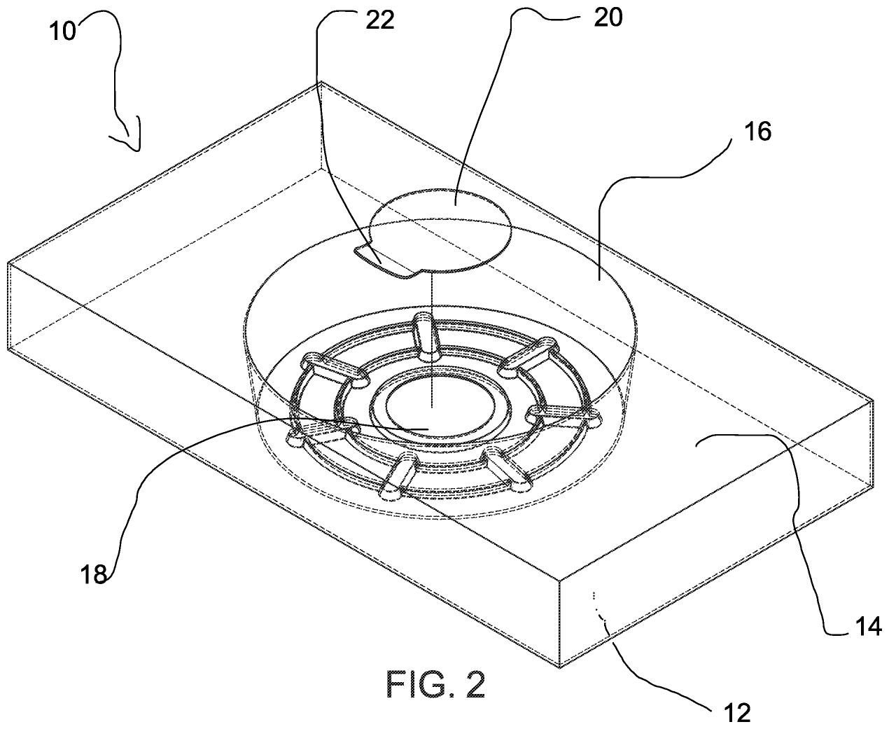

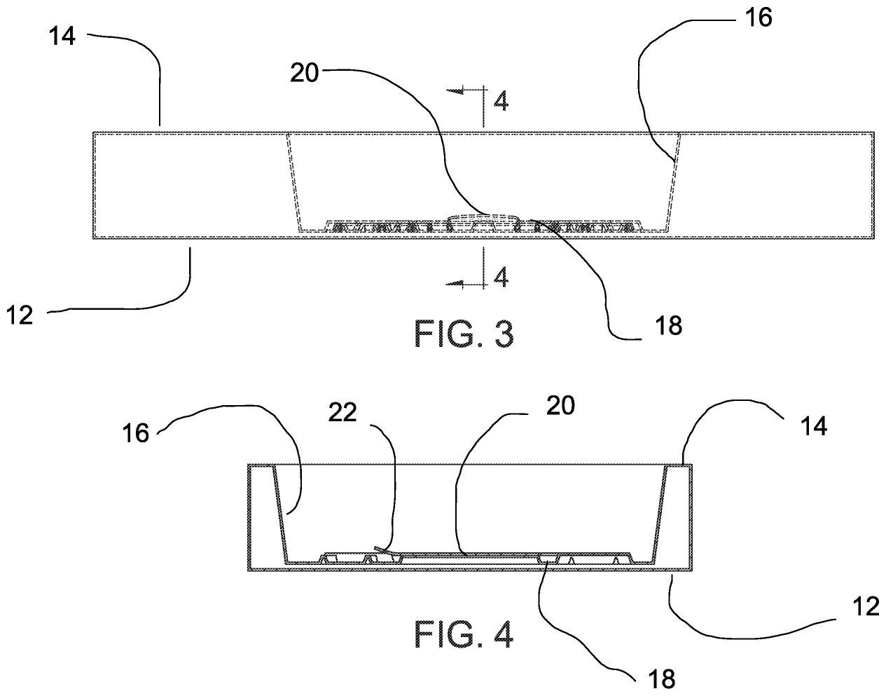

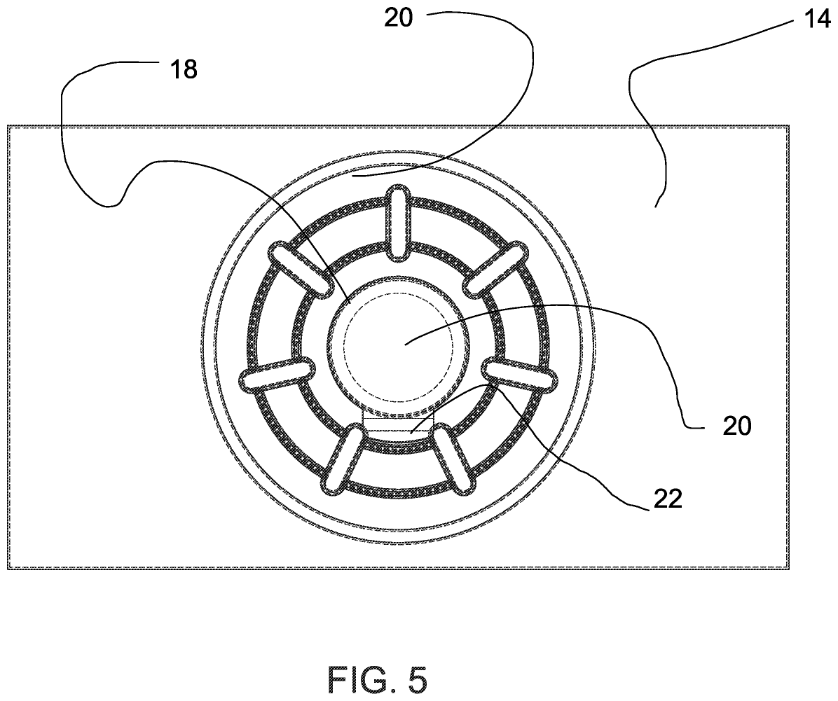

Referring to FIGS. 1-5, a first aspect of the invention is shown. The watering system vessel 10 has six sides forming the parallelepiped structure. The structure has a base 12 and a front 14, as well as four other side (not labelled). The front 14 has a depression defined by wall 16 forming a trough. The depression 16 is almost as deep as the distance between the base 12 and the front 14. The trough 16 is designed and configured to allow an animal, namely a pet, to freely drink therefrom. In the trough 16 there is an aperture 18 forming a passageway from the interior of the vessel 10 to the trough 16. The aperture 18 has a seal 20 that is removably secured to the aperture to prevent leakage therethrough. The seal 20 has a tab extension 22. The tab extension 22 allows for grasping of the seal 20 to remove it from the aperture 18. The seal 20 may be integrally formed with the trough 16, it may be hingedly attached to the aperture (similar to a flapper valve mechanism), or it may be adhesively secured over the aperture 18.

In use, the aspect according to FIGS. 1-5, the vessel 10 is situated upon a support surface (e.g., ground, floor, vehicle floorboard, etc.), not shown. The pull tab 22 is grasped and pulled so as to separate the seal 20 from the aperture 18. Once removed from the aperture 18, the predetermined volume of water begins to infiltrate the trough 16. The trough 16 is then made accessible to an animal to rehydrate after physical activity.

The structure of the vessel as described in FIGS. 1-5, as shown as a cuboid parallelepiped, may also be circular in base form, seen as concentric circles when viewed from above. This particular structure, albeit not shown, is well within the purview of this and the other disclosed embodiments.

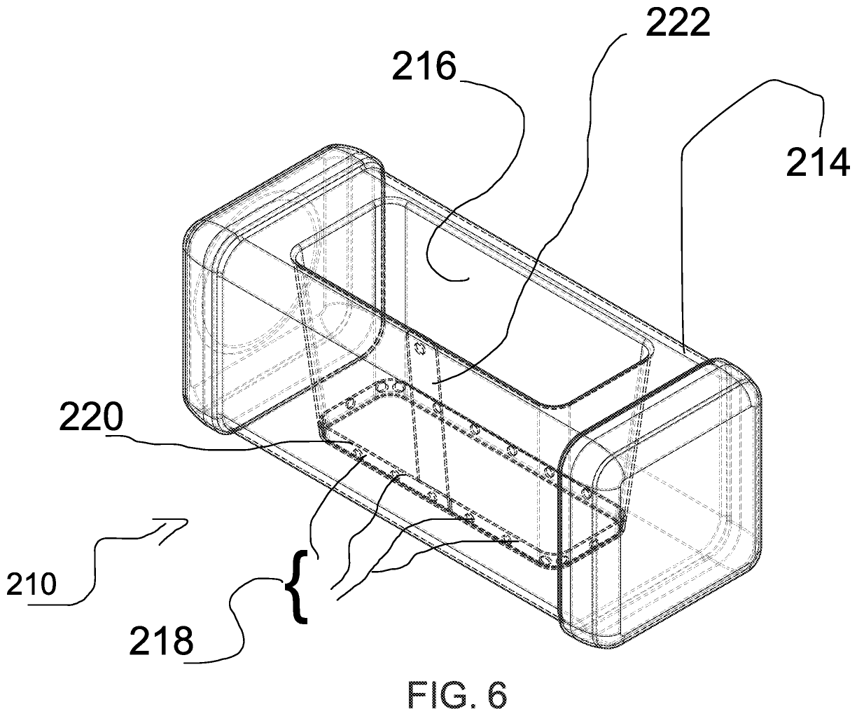

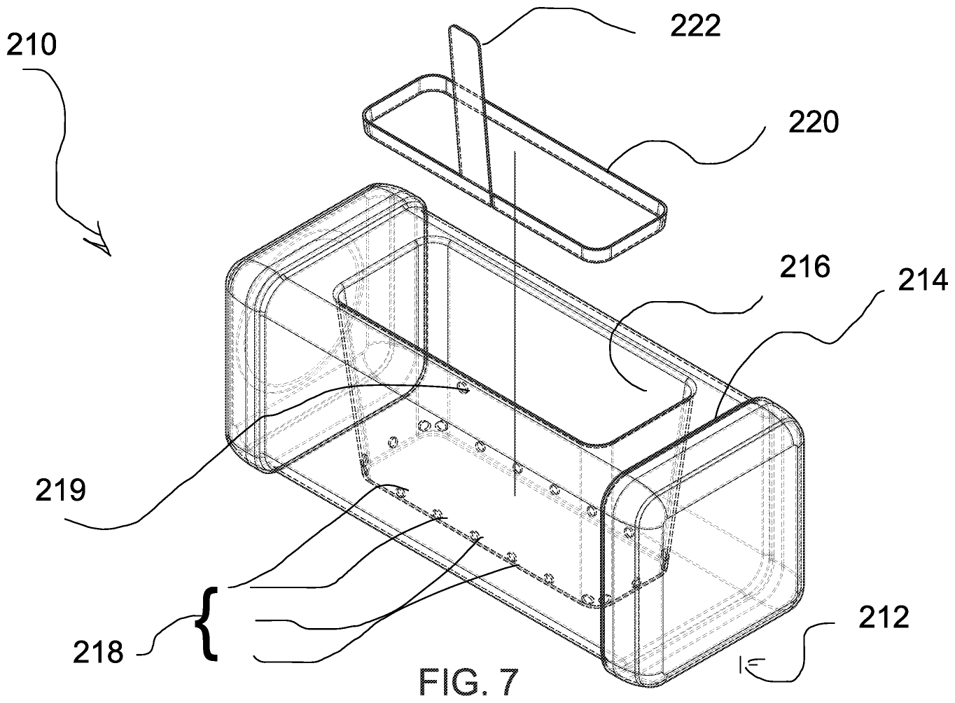

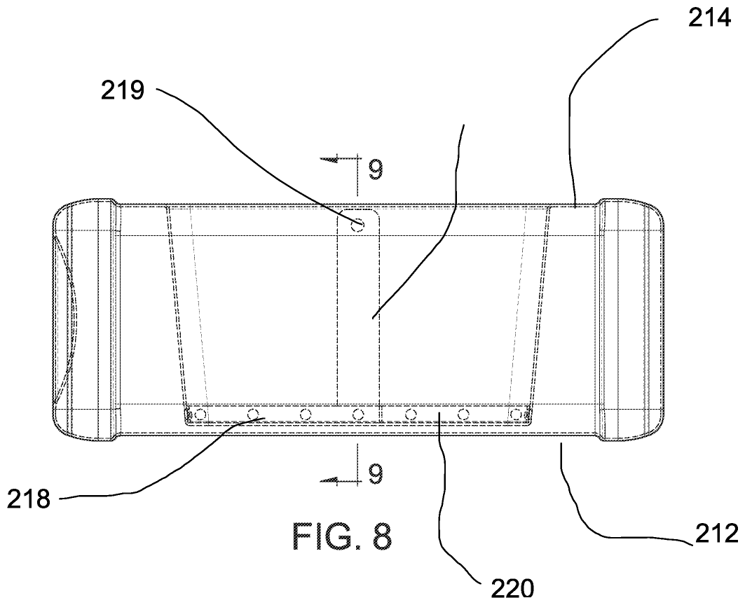

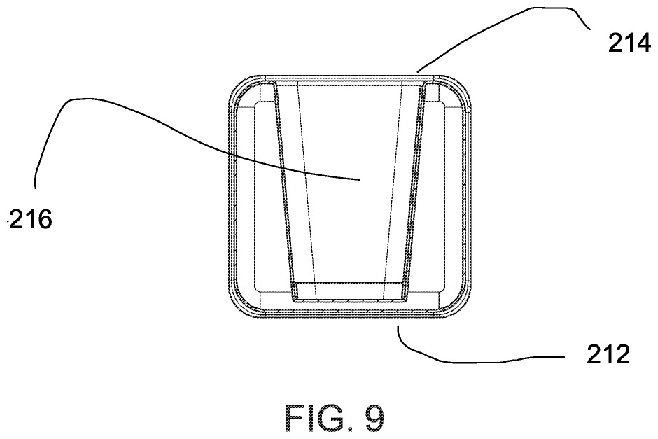

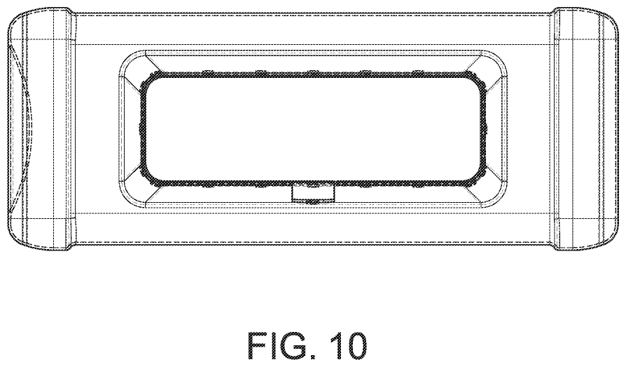

Referring to FIGS. 6-10, the preferred embodiment is shown and described herein. The watering system 210 has a generally rectangular cuboid parallelepiped form. In this form, and similar to FIGS. 1-5, vessel 210 has a base 212 and a front 214. In addition, there are four sides, not labeled adjoining the base 212 and the front 214, thereby completing the structural form. The interior of the vessel 212 is designed and configured to contain a predetermined amount of water by volume. The vessel 210 is a self-contained watering system to provide hydration to animals.

The front 214 of the vessel 210 has a depression defined by wall 216 forming a trough, also 216. The trough 216 extends into the vessel 210 almost as deep as the distance between the base 212 and the front 214. The trough 216 is designed and configured to allow an animal, namely a pet, to freely drink therefrom.

In the trough 216 there is a plurality of apertures 218 forming a passageway from the interior of the vessel 210 to the trough 216. In addition, there is another aperture 219 that also forms a passageway from the trough 216 to the interior of the vessel 210. The apertures 218 are equidistantly spaced around the closed end of the trough 216. The additional aperture 219 is positioned near the open end of the trough 216. A sealing band 220 extends around the wall of trough 216 near the closed end. The sealing band has an extension away from the closed end of the trough 216 and reaches toward the opened end thereof. The extension forms an additional seal over relief aperture 219 and provides the release tab 222 at the opened end of the trough 216.

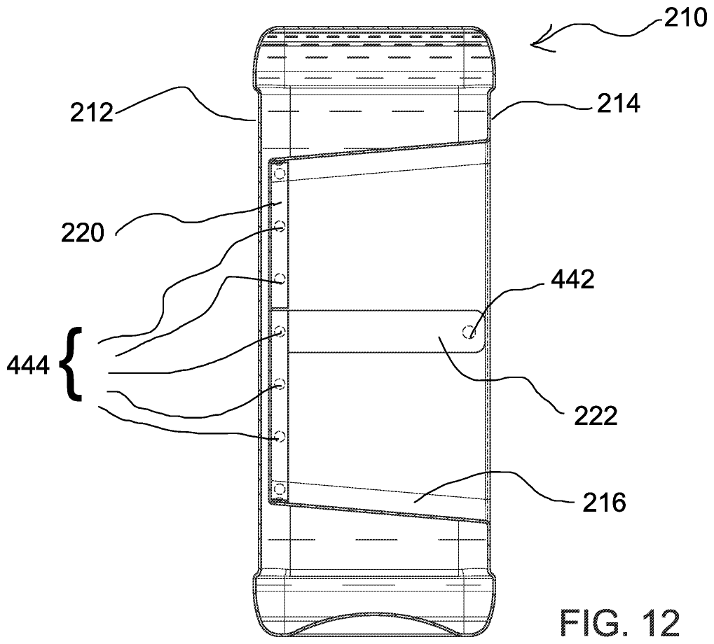

In conjunction with FIGS. 6-10. FIGS. 12-16 illustrate the best mode of the invention. All corresponding elements are the same throughout these illustrations. Referring to FIG. 12, the vessel 210 is shown in a vertically disposed to accommodate shelving presentation in retail or storage. The vessel is hermetically sealed with the interior filled with a predetermined volume of water 440. The vessel 210 is sized and configured to be portable, easily moved/positioned, and compact for easy access and usage.

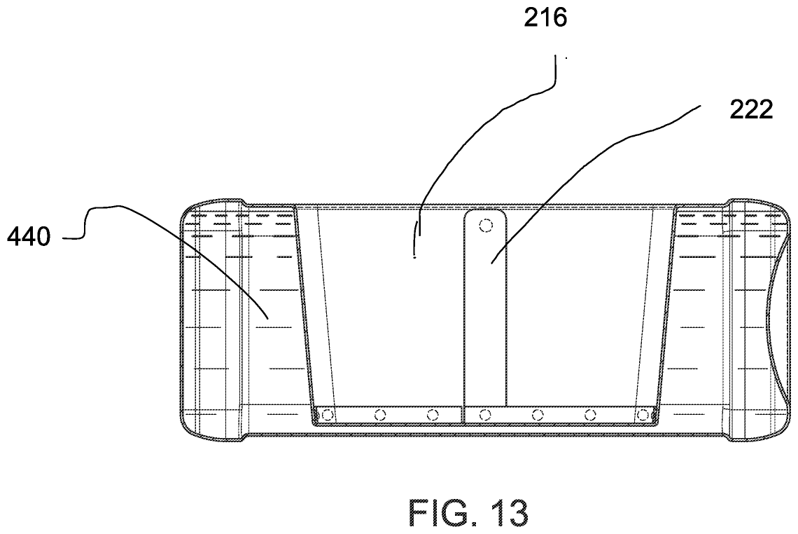

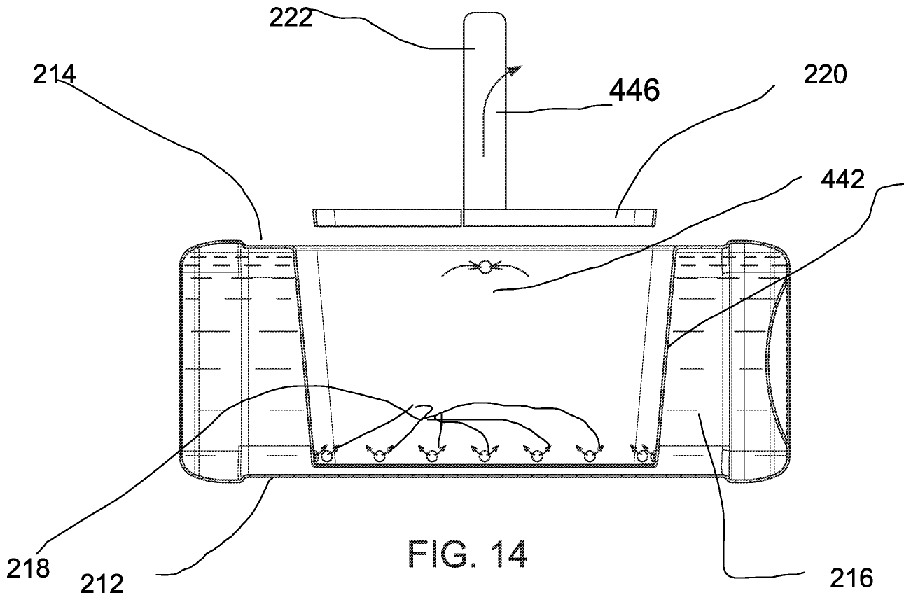

When facilitation of pet hydration is necessary, as shown in FIG. 13 the vessel 210 is placed on the base surface 212 upon a supporting surface, not shown. Through the open end of the trough 216, see FIG. 14, the pull tab 222 is grasped and gently yet forcibly pulled, shown by arrow 446 to release the seal 220 from the relief aperture 219 and simultaneously/subsequently from water apertures 218.

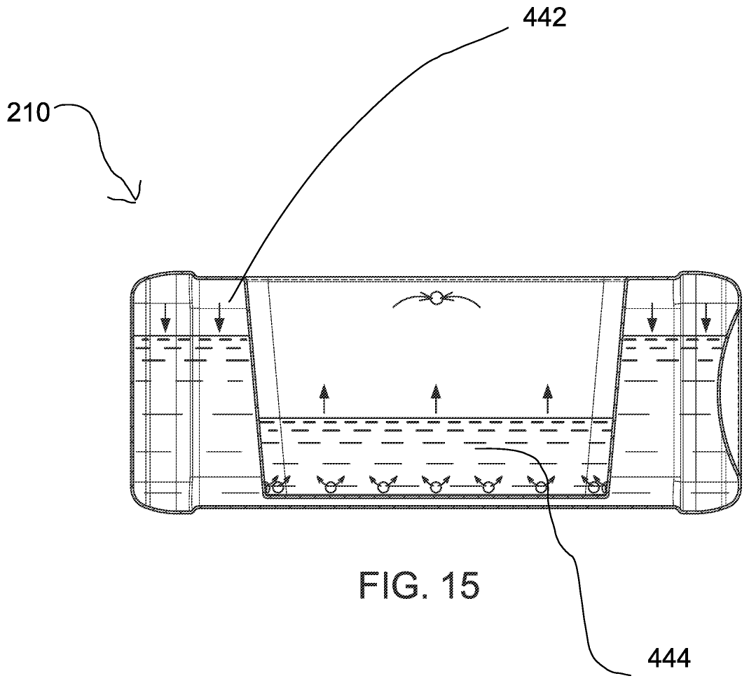

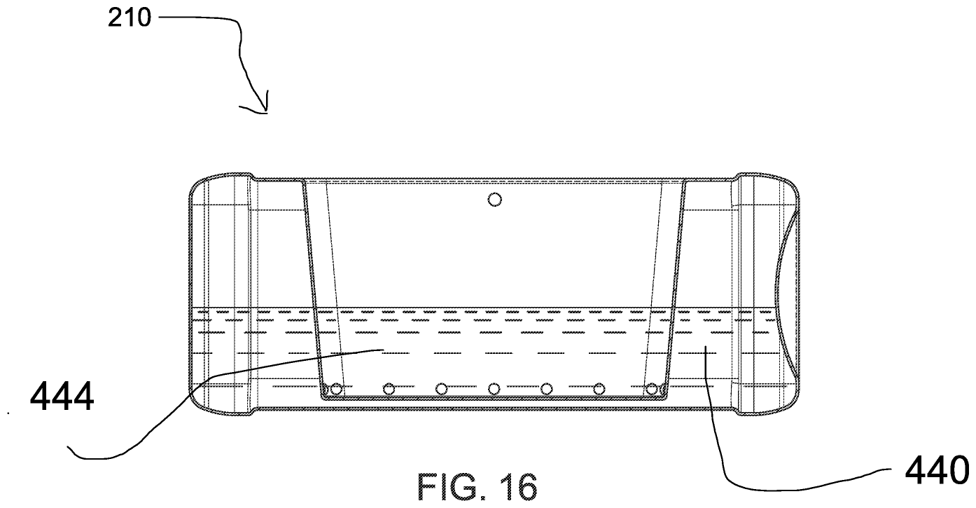

Once the seal 220 is removed, as shown in FIG. 15 from the internal cavity of vessel 210 begins a flow of water 444 through the water apertures 218, and simultaneously air in fed into the interior cavity via the relief aperture 219, until a point of equilibrium is matched between the level of water 444 in the trough 216 and in the interior of the vessel 210 illustrated in FIG. 16. As the water 444 drains into the trough 216, air 442 fills the interior of the vessel 210. As the animal drinks the water 444 from the trough 216, the water from the interior cavity of the vessel 210 replenishes into the trough 216 through the apertures 218, likewise air is drawn into the interior cavity of the vessel via the relief aperture 219.

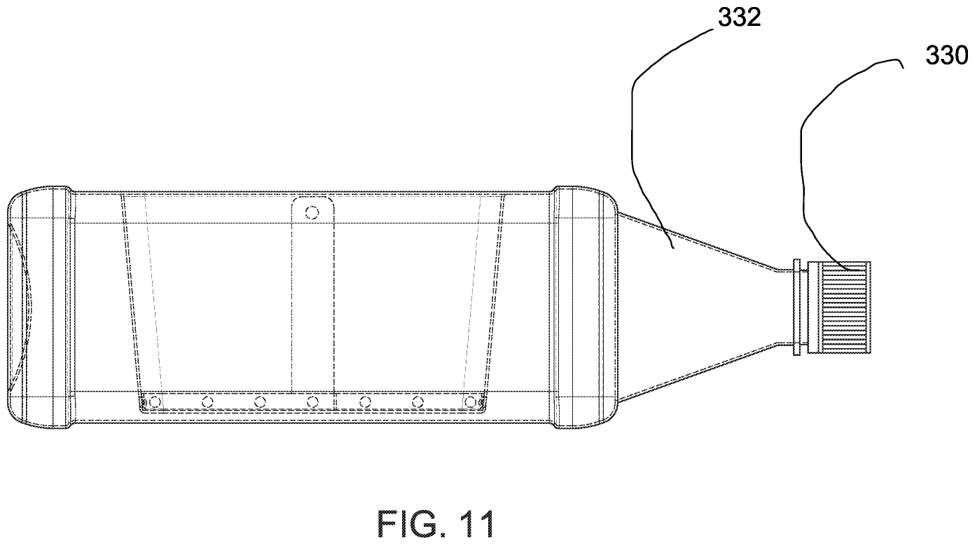

Referring to FIG. 11, a preferred vessel 210 configuration is displayed. In FIG. 11, the vessel has a reusability aspect. The vessel 210 is shown with a tapering neck 332 from one of the other sides of the vessel 210 between the base 212 and front 214 surfaces. This illustrative neck 330 provides an outer threaded port (not shown) the engages with the inner threaded cap 330. In this arrangement, the cap 330 is removed from the neck 332, providing an access to add water 444 into the inner cavity of the vessel 210. Once refilled, the cap 330 is replaced and along with the seal 220 covering the water apertures 218 and the relief aperture 219, restores the vessel 210 to a self-contained reusable water delivery system for animals. This configuration is not restricted to the illustrated neck 332 and cap 330, but rather this is a suitable modification of the preferred embodiment of FIGS. 6-10. Other types of refillable ports include, but are not limited to, an internally threaded port formed in the end side surface and a mating externally threaded cap, a port hole with an accompanying resilient stopper, and a locking flap type closure and port. These modifications are well within the design purview of the artisan, and the exact refilling orifice is not limited to what is disclosed herein.

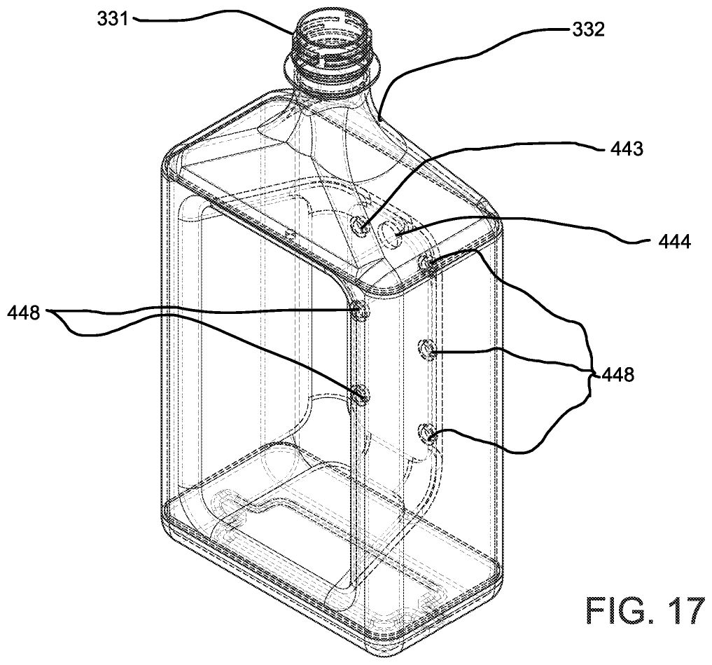

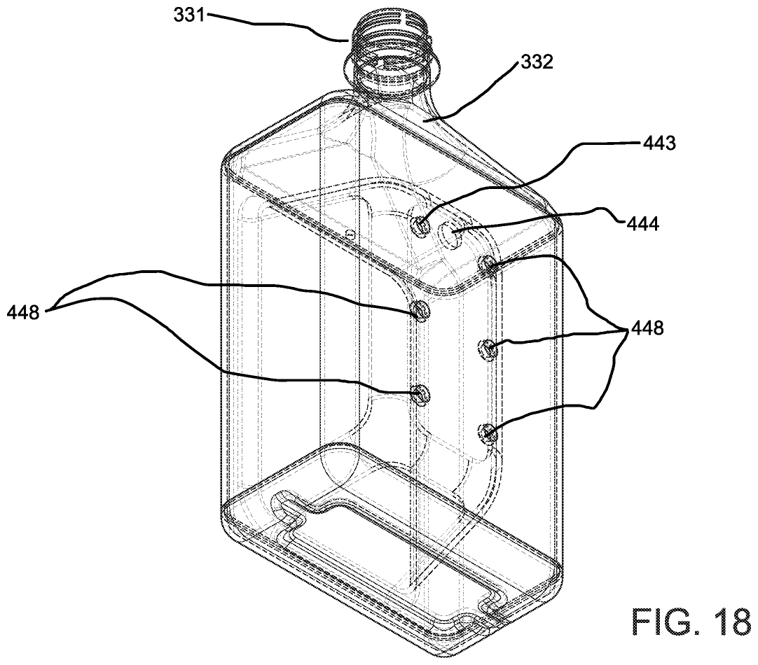

FIGS. 17 and 18 provide an elevational view of the pet watering device having a main body as described and shown above. The aspects illustrated in these figures are shown as connections within the interior of the container between the bottom of the trough 216 and the inner side of the container. The connections are shown at 448. These connections may be made in accordance with common practices such as injection molding, ultrasonic welding, spot bonding, etc. The purpose of these connections is to prevent the bowl from deformation during periods of inclement weather such as very high temperatures in the ambient vicinity. Connections 448 are completely internal of the container and do not interfere with the water flow from the interior of the container into the trough 216 of the invention.

Also, in FIGS. 17 and 18, is an alternate port for equalizing the internal and external pressures when the seals are removed so that the water will flow from the interior of the container to the trough 216. As discussed above, port 444 in the bottom of the bowl allows the flow of water out from the interior of the container. While port 443, which resides in the neck 332 of the container, it allows air to enter into the interior of the container, as the water flows through the port 443 into the bowl of the container, thereby providing water for the pet to drink. Although not shown, the cap 330 (see FIG. 11) engages and mates with the threads 331, as seen in FIGS. 17 and 18.

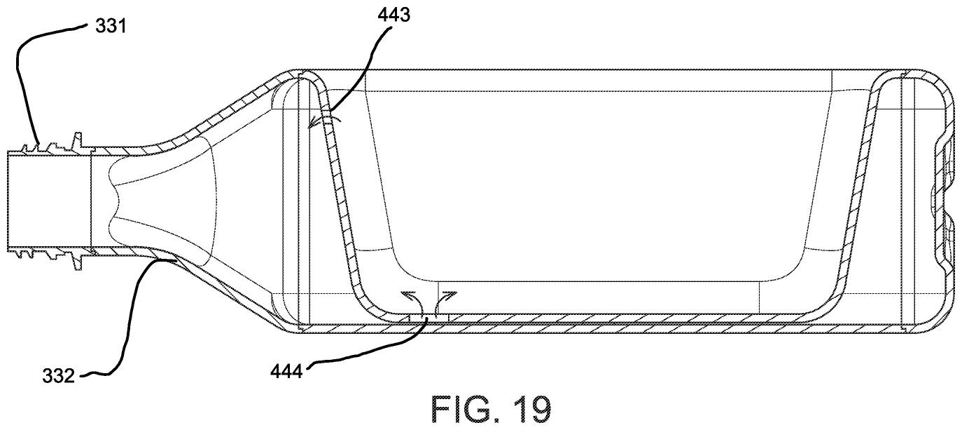

As seen in FIG. 19, port 444 in the bottom of the bowl allows the flow of water out from the interior of the container. While port 443, which resides in the neck 332 of the container, allows air to enter into the interior of the container, as the water flows through the port 443 into the trough 216 of the container, thereby providing water for the pet to drink.

Groupings of alternative elements or embodiments disclosed herein are not to be construed as limitations. Each group member may be referred to and claimed individually or in any combination with other members of the group or other elements disclosed herein. One or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

The use of any and all examples, or exemplary language (e.g., “such as”) provided herein is intended merely for clarification and does not pose a limitation on the scope of the present disclosure. No language in the specification should be construed as indicating any non-claimed element essential to the practice of any embodiments discussed herein. The apparatus, methods, and articles of manufacture described herein may be implemented in a variety of embodiments, and the foregoing description of some of these embodiments does not necessarily represent a complete description of all possible embodiments. Instead, the description of the drawings, and the drawings themselves, disclose at least one embodiment, and may disclosure alternative embodiments.

The term “substantially” when used to describe a characteristic, parameter, property, or value of an element may represent deviations or variations that do not diminish the characteristic, parameter, property, or value that the element may be intended to provide. Deviations or variations in a characteristic, parameter, property, or value of an element may be based on, for example, tolerances, measurement errors, measurement accuracy limitations and other factors. The term “proximate” is synonymous with terms such as “adjacent,” “close,” “immediate,” “nearby”, “neighboring”, etc., and such terms may be used interchangeably as appearing in this disclosure.

Although certain example apparatus, methods, and articles of manufacture have been described herein, the scope of coverage of this disclosure is not limited thereto. On the contrary, this disclosure covers all apparatus, methods, and articles of articles of manufacture fairly falling within the scope of the appended claims either literally or under the doctrine of equivalents.

What is claimed is:

1. A portable watering system for animals, comprising:
a vessel defining an internal volume for holding a predetermined volume of water, the vessel having at least one base side, and at least one front side opposite the base side;
the front side having a depression into the vessel forming a trough;
the trough having at least one aperture;
a removable sealing member adjacent to the at least one aperture;
wherein upon placing the at least one base side on a support surface and removing the removable seal covering the at least one aperture, water contained in the chamber enters the trough;
whereby water is provided for consumption by an animal.

2. The portable watering system for animals according to claim 1, further comprising:
a removable and replaceable cover provided on the vessel on a side joining the base and front side;
wherein the vessel is predominantly the form of a parallelepiped;
wherein the cover allows the replenishment of water to the internal volume.

3. The portable watering system for animals according to claim 2, wherein the vessel is fabricated of biodegradable material, the removable seal is fabricated of biodegradable material, and the cover is fabricated of biodegradable material.

4. The portable watering system for animals according to claim 2, wherein the vessel is fabricated of reusable plastics, the removable seal is fabricated of reusable plastics, and the cover is fabricated of reusable plastics.

5. The portable watering system for animals according to claim 1, wherein the at least on aperture further comprising:
at least a first and a second apertures;
the first aperture is disposed adjacent to the bottom of the depression;
the second aperture is disposed adjacent to the top of the depression;
wherein the first aperture allows water to flow from the interior of the vessel into the trough, and wherein the second aperture allows air to flow into the interior of the of the vessel;
whereby an equilibrium of internal and external pressures about the vessel is established.

6. The portable watering system for animals according to claim 5, wherein the first aperture includes a plurality of apertures spaced equidistantly around the trough adjacent the bottom of the depression.

7. The portable watering system for animals according to claim 5, wherein the removable seal is disposed about the bottom of the depression covering all of the first apertures and includes a vertically disposed extension covering the second aperture;
wherein the vertically disposed extension provides a graspable end for removing the seal with a pull;
whereby the seal may be returned to reseal the apertures for reuse of the vessel.

8. The portable watering system for animals according to claim 1, wherein the vessel is predominantly in the form of a parallelepiped.

9. The portable watering system for animals according to claim 8, wherein the parallelepiped is selected from the group containing: a rectangular cuboid, a square cuboid, or a cube.

10. The portable watering system for animals according to claim 9, wherein the vessel is fabricated from plastic and reusable.

11. The portable watering system for animals according to claim 9, wherein the vessel is fabricated from biodegradable materials.

12. The portable watering system for animals according to claim 11, wherein the vessel is disposable.

13. A pet watering device comprising:
a substantially parallelepiped body having front side, a base side, and four other sides, the body supporting an internal, self-contained volume of water disposed therein;
wherein the front side is opposite the base side;
a depression in the front side extending inwardly of the body, the depression defining a trough;
at least one aperture disposed within the trough;
a seal covering the at least one aperture;
the seal having a pull tab end for selectively grasping and removing the seal from the aperture;
wherein the seal is selectively removable from, and replaceable to the at least one aperture;
a port formed in one of the other sides; and
a closure for the port;
wherein the port is used to refill the internal volume with water on demand.

14. The pet watering device according to claim 13, wherein the port and the closure form a hermetic seal.

15. The pet watering device according to claim 14, wherein the port and the closure are designed and configured as an orifice and snap fit stopper.

16. The pet watering device according to claim 15, wherein the body is formed of a material selected from the group consisting of plastics, biodegradable materials, glass, paper, and plant-based materials.

17. The pet watering device according to claim 13,
wherein the at least one aperture includes a plurality of first apertures and a second aperture;
wherein the plurality of first apertures is disposed adjacent to the closed end of the trough;
the second aperture is disposed adjacent to the open end of the trough;
wherein the plurality of first apertures allows water to flow from the interior of the body into the trough, and wherein the second aperture allows air to flow into the interior of the of the body;
whereby an equilibrium of internal and external pressures about the vessel is established allowing the trough to hold water for pets to drink.

18. The pet watering device according to claim 13, further comprising:
a plurality of connecting joinders on the interior of the body between the trough bottom and the opposite container wall, the connecting joinders preventing the trough from becoming deform in the event of high temperatures;
wherein the body being designed and configured to be portable; and
wherein the body being designed and configured to be reusable.

19. The pet watering device according to claim 13, further comprising:
a plurality of connecting joinders on the interior of the body between the trough bottom and the opposite container wall, the connecting joinders preventing the trough from becoming deform in the event of high temperatures;
the body being designed and configured to be portable; and
the body being designed and configured to be disposable.

20. A pet watering device comprising:
a substantially parallelepiped body having front side, a base side, and four other sides, the body supporting an internal, self-contained volume of water disposed therein;
wherein the front side is opposite the base side;
a depression in the front side extending inwardly of the body, the depression defining a trough;
a plurality of connecting joinders on the interior of the body between the trough bottom and the opposite container wall, the connecting joinders preventing the trough from becoming deform in the event of high ambient temperatures
at least two apertures disposed within the trough;
a seal covering the at least two apertures;
the seal having a pull tab end for selectively grasping and removing the seal from the apertures;
wherein the seal is selectively removable from, and replaceable to the at least one aperture;
a port designed and configured as a bottle neck having a threaded end around the port;
wherein one of the at least two apertures is formed near the opened end of the trough and adjacent to the bottle neck of the port; and
a closure designed and configured as a corresponding threaded cap for the meshing with the threaded end;
wherein the threaded cap seals port by selectively engaging the threaded end;
wherein the port is used to refill the internal volume with water upon selectively removing the threaded cap.
